(19) United States
(12) Patent Application Publication
(10) Pub. No.: US 2007/0052658 A1
(43) Pub. Date: Mar. 8, 2007

(54) Driver for display apparatus and display apparatus including the same

(76) Inventor: Sung-Man Kim, Seoul (KR)

Correspondence Address: CANTOR COLBURN, LLP, 55 GRIFFIN ROAD SOUTH, BLOOMFIELD, CT, 06002, US

(21) Appl. No.: 11/516,836

(22) Filed: Sep. 7, 2006

(30) Foreign Application Priority Data
Sep. 7, 2005 (KR) 10-2005-0083039

(51) Int. Cl. G09G 3/36

(52) U.S. Cl. 345/100

(57) ABSTRACT

Provided is a driver for a display apparatus and a display apparatus having the same. The driver includes a plurality of gate lines that transmit gate signals, and first and second gate drivers that are respectively connected to odd-numbered and even-numbered gate lines among the plurality of gate lines and generate the gate signals based on a plurality of clock signals, wherein two adjacent clock signals among the plurality of clock signals have a phase difference equal to or greater than 180° and less than 360°. Accordingly, voltage drop caused by a kickback voltage occurs only one time by allowing two adjacent clock signals to have a predetermined time delay from each other, so that a positive data voltage is the same as a negative data voltage, thereby preventing flicker or stain.

This application claims priority to Korean Patent Application No. 10-2005-0083039, filed on Sep. 7, 2005, and all of the benefits accruing therefrom under 35 U.S.C. §119, the contents of which in its entirety are herein incorporated by reference.

### BACKGROUND OF THE INVENTION

(a) Field of the Invention

The present invention relates to a driver for a display apparatus and a display apparatus having the same.

(b) Description of the Related Art

In general, a liquid crystal display (“LCD”) apparatus includes two panels provided with pixel electrodes and a common electrode, and a liquid crystal layer that has dielectric anisotropy interposed between the two panels. The pixel electrodes are arranged in a matrix form. The pixel electrodes are connected to switching elements such as thin film transistors (“TFTs”) to be sequentially applied with data voltage in units of a pixel row. The common electrode is disposed over the entire surface of the panel and is applied with a common voltage. In terms of circuit theory, the pixel electrodes and the common electrode together with the liquid crystal layer interposed therebetween constitute a liquid crystal capacitor. The liquid crystal capacitor together with the switching elements connected thereto become a pixel unit.

In the liquid crystal display apparatus, voltages are applied to two electrodes (e.g., pixel electrode and common electrode) to generate an electric field in the liquid crystal layer. By controlling the electric field strength to adjust transmittance of light passing through the liquid crystal layer, a desired image is obtained. If the electric field is applied in one direction to the liquid crystal layer for a long period of time, deterioration in image quality may occur. Therefore, there is a need to invert polarities of data voltages with respect to the common voltage applied to the common electrode in units of frames, pixel rows, or pixels.

The liquid crystal display apparatus includes a gate driver for transmitting a gate signal to gate lines to turn switching elements of respective pixels on and off, a gray voltage generator for generating a plurality of gray voltages, a data driver for selecting a voltage corresponding to image data from the gray voltages and applying a data voltage to a data line among display signal lines, and a signal controller for controlling these components.

The gate driver is formed in the same process as used for forming the switching elements of the pixels, and thus, the gate driver is then integrated into the panel. The number of data lines is reduced by half instead of doubling the number of gate lines, thereby realizing the same resolution and reducing cost. Furthermore, a pair of opposing gate drivers is disposed on the left and right sides of the panel to apply the gate signal. In order to apply the gate signal for a time period of one frame, a next gate signal is transmitted by overlapping the next gate signal with a previous gate signal after a predetermined time has elapsed after the previous gate signal is applied.

When the signal lines overlap, parasitic capacitance is formed in a pixel. After a data voltage is applied, the data voltage is slightly reduced due to a kickback voltage generated by the parasitic capacitance at a falling edge, and is thereafter reduced again due to the kickback voltage at a falling edge of a next gate signal. This causes a voltage difference between positive and negative pixel voltages, resulting in flicker. Further, a screen may be stained by a residual image or fingerprint.

Accordingly, there is a desire for a driver for a display apparatus which prevents flicker or stain of a screen, and a display apparatus having the same.

### BRIEF SUMMARY OF THE INVENTION

The present invention has been made in an effort to provide a driver for a display apparatus and a display apparatus having the same having advantages of preventing flicker or stain of a screen.

An exemplary embodiment of the present invention provides a driver for a display apparatus.

According to an exemplary embodiment of the present invention, a driver for a display apparatus includes a plurality of gate lines which transmit gate signals, and first and second gate drivers respectively connected to odd-numbered and even-numbered gate lines among the plurality of gate lines, the first and second gate drivers generate the gate signals based on a plurality of clock signals. Two adjacent clock signals among the plurality of clock signals have a phase difference equal to or greater than 180° and less than 360°.

In addition, two non-adjacent clock signals among the plurality of clock signals may have a phase difference of 180°.

The plurality of clock signals may each have a duty ratio of 50%.

The plurality of clock signals includes first to fourth clock signals, and the first and second clock signals or the third and fourth clock signals may have phase differences equal to or greater than 180° and less than 360°.

The first and third clock signals or the second and fourth clock signals may have phase differences of 180°.

The first and third clock signals may be input to the first gate driver, the second and fourth clock signals may be input to the second gate driver, first and second output start signals may be respectively input to the first and second gate drivers, and the first and second output start signals may have a phase difference equal to or greater than 180° and less than 360°.

Another exemplary embodiment of the present invention provides a display apparatus, which includes a plurality of pixels arranged in a matrix, a plurality of gate lines for transmitting a gate signal to the pixels, a plurality of data lines for transmitting a data signal to the pixels, and first and second gate drivers respectively connected to odd-numbered and even-numbered gate lines among the plurality of gate lines, the first and second gate drivers generate the gate signal based on a plurality of clock signals. Two adjacent clock signals among the plurality of clock signals have a phase difference equal to or greater than 180° and less than 360°.

In addition, two non-adjacent clock signals among the plurality of clock signals may have a phase difference of 180°.

The plurality of clock signals may each have a duty ratio of 50%.

The plurality of clock signals may include first to fourth clock signals, and the first and second clock signals or the third and fourth clock signals may have phase differences equal to or greater than 180° and less than 360°.

The first and third clock signals or the second and fourth clock signals may have phase differences of 180°.

The first and third clock signals may be input to the first gate driver, and the second and fourth clock signals may be input to the second gate driver.

First and second output start signals may be respectively input to the first and second gate drivers, and the first and second output start signals may have a phase difference equal to or greater than 180° and less than 360°.

Two contiguous pixels (“a pair of adjacent pixels”) disposed in a row direction between two adjacent data lines among the plurality of pixels may be connected to a same data line, and the two pixels may be connected to different gate lines from each other.

The display apparatus may further include a data driver for generating the data signal, wherein the data driver applies the data signal to a pixel that first receives the gate signal between the two contiguous pixels located in a first pixel row among a plurality of pixel rows arranged in a column direction.

The first and second gate drivers may be integrated into the display apparatus.

### BRIEF DESCRIPTION OF THE DRAWINGS

The above and other features and advantages of the present invention will become more apparent by describing in more detail exemplary embodiments thereof with reference to the attached drawings, in which:

FIG. 1 is a block diagram showing a liquid crystal display apparatus according to an exemplary embodiment of the present invention;

FIG. 2 is an equivalent circuit schematic diagram showing a pixel of a liquid crystal display apparatus according to an exemplary embodiment of the present invention;

FIG. 3 shows a structure of a liquid crystal display apparatus according to an exemplary embodiment of the present invention;

FIG. 4 is a block diagram of a gate driver according to an exemplary embodiment of the present invention;

FIG. 5 is a circuit schematic diagram of a j-th stage of a shift register for a gate driver according to an exemplary embodiment of the present invention;

FIGS. 6A and 6B show signal waveforms of the gate driver of FIG. 4;

FIGS. 7A and 7B show waveforms of a gate signal and a data voltage according to an exemplary embodiment of the present invention and the prior art, respectively; and

FIG. 8 shows a partial waveform of a gate signal output for a gate driver according to an exemplary embodiment of the present invention.

### DETAILED DESCRIPTION OF THE INVENTION

Exemplary embodiments of the present invention will hereinafter be described with reference to the accompanying drawings. The present invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, the present invention will be described with reference to the accompanying drawings.

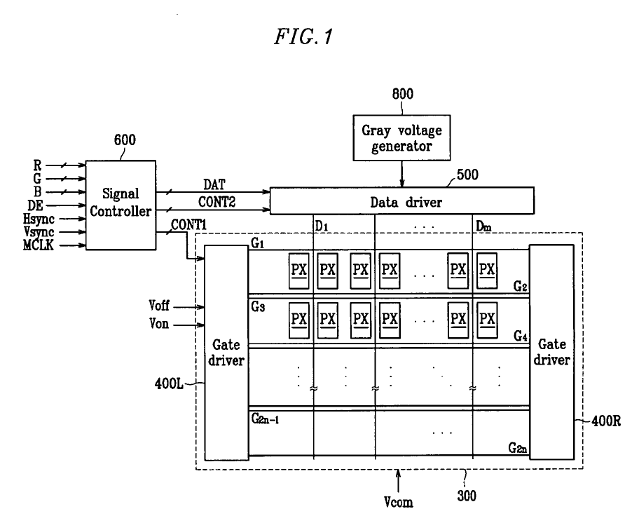

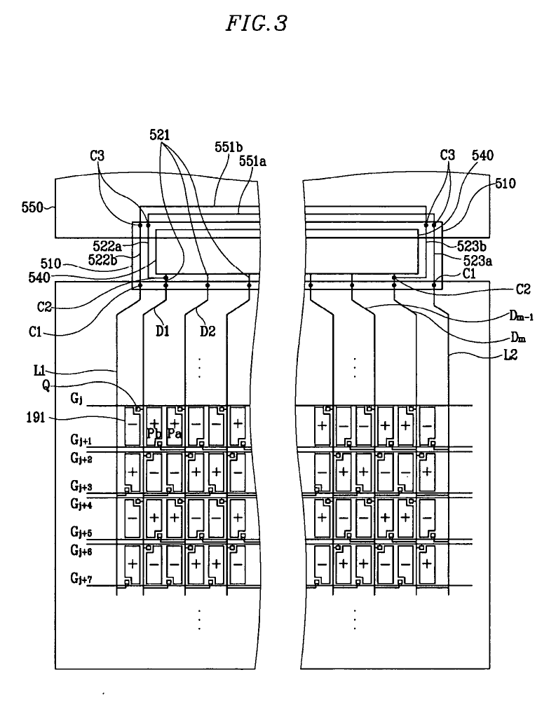

First, a liquid crystal display apparatus as an example of a display apparatus according to an exemplary embodiment of the present invention will be described with reference to FIGS. 1 and 3.

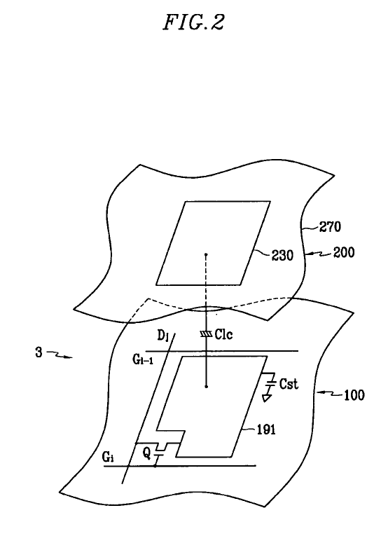

FIG. 1 is a block diagram showing a liquid crystal display apparatus according to an exemplary embodiment of the present invention. FIG. 2 is an equivalent circuit schematic diagram showing a pixel of a liquid crystal display apparatus according to an exemplary embodiment of the present invention. FIG. 3 shows a structure of a liquid crystal display apparatus according to an exemplary embodiment of the present invention.

As shown in FIG. 1, a liquid crystal display apparatus according to the exemplary embodiment of the present invention includes a liquid crystal panel assembly 300, gate drivers 400L and 400R and a data driver 500 that are connected to the liquid crystal panel assembly 300, a gray voltage generator 800 connected to the data driver 500, and a signal controller 600 for controlling these components.

As best seen with reference to FIGS. 1 and 3, the liquid crystal panel assembly 300 includes a plurality of signal lines G₁ to G₂ₙ, D₁ to Dₘ, L1, and L2. In addition, a plurality of pixels PX that are connected thereto are arranged substantially in a matrix.

The signal lines G₁ to G₂ₙ, D₁ to Dₘ, L1, and L2 include a plurality of gate lines G₁ to G₂ₙ for transmitting gate signals (sometimes referred to as “scan signals”) and a plurality of data lines D₁ to Dₘ and dummy lines L1 and L2 for transmitting data signals. The gate lines G₁ to G₂ₙ extend in parallel to each other substantially in a row direction, and the data lines D₁ to Dₘ and dummy lines L1 and L2 extend in parallel to each other substantially in a column direction.

As shown in FIG. 3, a printed circuit board (“PCB”) 550 is disposed at an upper portion of the liquid crystal panel assembly 300 having the gate lines G₁ to G₂ₙ, the data lines D₁ to Dₘ, and the dummy lines L1 and L2. The PCB 550 includes circuit elements such as a signal controller 600 for driving the liquid crystal display apparatus, a driving voltage generator, and a gray voltage generator (both not shown). The dummy lines L1 and L2 extend in parallel to each other substantially in a column direction respectively at the leftmost edge and the rightmost edge of the liquid crystal panel assembly 300, and are substantially parallel to the data lines D₁ to Dₘ.

The liquid crystal panel assembly 300 and the PCB 550 are electrically and physically connected to each other through a flexible printed circuit (“FPC”) substrate 510.

The FPC substrate 510 is mounted with a data driving integration circuit chip 540 constituting the data driver 500, and is formed with a plurality of data transmission lines 521. The data transmission lines 521 are respectively connected to the data lines D₁ to Dₘ formed on the liquid crystal panel assembly 300 to transmit corresponding data voltages through a contact portion C1.

Signal transmission lines 522a, 522b, 523a and 523b are formed in the FPC substrate 510 at the leftmost and rightmost positions of the data driving integration circuit chip 540. The signal transmission lines 522a, 522b, 523a and 523b are connected to signal transmission lines 551a and 551b formed in the PCB 550 through a corresponding contact portion C3.

The signal transmission line 522a formed in the leftmost side of the FPC substrate 510 is connected to the leftmost data line D1 through a contact portion C2, and is connected to the signal transmission lines 551a and 523a through the contact portion C3 so as to be connected to a dummy line L2 through the contact portion C1.

The signal transmission line 523b formed at the rightmost side of the substrate 510 is connected to the rightmost data line Dm through the contact portion C2, and is connected to the signal transmission lines 551b and 523b through the contact portion C3 so as to be connected to the dummy line L1 through the contract portion C1.

Each pixel PX includes a switching element Q connected to the display signal lines G₁ to G₂ₙ and D₁ to Dₘ and the dummy lines L1 and L2, a liquid crystal capacitor Clc connected thereto, and a storage capacitor Cst as seen in FIGS. 2 and 3. The storage capacitor Cst, however, may be optionally omitted.

The switching element Q, such as a thin film transistor, is disposed on a lower panel 100 of a thin film transistor panel. As a three-port device, its control port is connected to one of the gate lines G₁ to G₂ₙ, its input port is connected to one of the data lines D₁ to Dₘ and the dummy lines L1 and L2, and its output port is connected to the liquid crystal capacitor Clc and the storage capacitor Cst.

Two ports of the liquid crystal capacitor Clc are a pixel electrode 191 of the lower panel 100 and a common electrode 270 of an upper panel 200, which is a common electrode panel. A liquid crystal layer 3 interposed between the two electrodes 191 and 270 serves as a dielectric member. The pixel electrode 191 is connected to the switching element Q, and the common electrode 270 is disposed on the entire surface of the upper panel 200 to receive a common voltage Vcom. Unlike that shown in FIG. 2, the common electrode 270 may be disposed on the lower panel 100 instead of the upper panel 200, and in this case, at least one of the two electrodes 191 and 270 may be formed in a shape of a line or a bar.

The storage capacitor Cst having an auxiliary function for the liquid crystal capacitor Clc is constructed by overlapping a separate signal line (not shown) and the pixel electrode 191 provided on the lower panel 100 with an insulating member interposed therebetween, and a predetermined voltage such as the common voltage Vcom is applied to the separate signal line. Alternatively, the storage capacitor Cst may be constructed by overlapping the pixel electrode 191 with a front gate line disposed just above it with an insulating member interposed therebetween.

As shown in FIG. 3, a pair of gate lines Gⱼ₊₁ and Gⱼ₊₂, and Gⱼ₊₃ and Gⱼ₊₄, are respectively disposed above and below a single row of the pixel electrodes 191. In addition, each of the data lines D₁ to Dₘ is disposed between two adjacent columns of the pixel electrodes 191. That is, one data line is disposed between a pair of pixel columns. Now, connection between the gate lines G₁ to G₂ₙ and the pixel electrodes 191, and connection between the data lines D₁ to Dₘ and the pixel electrodes 191, will be described in detail.

A plurality of pairs of gate lines G₁ to G₂ₙ connected above and below the pixel electrodes 191 are connected thereto through switching elements Q disposed above and below each pixel electrode 191.

That is, in an odd-numbered pixel row, switching elements Q disposed at the left side of the respective data lines D₁ to Dₘ are connected to the upper gate lines G₁, G₅, . . . , G₄ₘ₊₁, whereas switching elements Q disposed at the right side of the D₁ to Dₘ are connected to the lower gate lines G₂, G₆, . . . , G₄ₘ₊₂. On the other hand, in an even-numbered pixel row, the upper gate lines G₃, G₇, . . . , G₄ₘ₋₁ and the lower gate lines G₄, G₈, . . . , G₄ₘ are connected to the switching elements Q in the opposite manner with respect to the odd-numbered pixel row. That is, switching elements Q disposed at the right side of the data lines D₁ to Dₘ are connected to the upper gate lines G₃, G₇, . . . , G₄₋₁, whereas switching elements Q disposed at the left side of the D₁ to Dₘ are connected to the lower gate lines G₄, G₈, . . . , G₄ₘ.

In the odd-numbered row, a pixel electrode 191 disposed at the left side of the data lines D₁ to Dₘ is connected to first-adjacent data lines D₁ to Dₘ through its switching element Q, whereas a pixel electrode 191 disposed in the right side of the D₁ to Dₘ is connected to second-adjacent data lines D₁ to Dₘ. In the even-numbered row, a pixel electrode 191 disposed at the left side of the data lines D₁ to Dₘ is connected to previous-adjacent data lines D₁ to Dₘ through its switching element Q, whereas a pixel electrode 191 disposed at the right side of the D₁ to Dₘ is connected to first-adjacent data lines D₁ to Dₘ. In addition, a pixel electrode 191 in the first column and in the even-numbered row is connected to the dummy line L1 connected to a last dummy line Dm, whereas a pixel electrode 191 in the last column and in the odd-numbered row is connected to the dummy line L2 connected to the first data line D1.

As described above, the switching elements Q respectively formed in each pixel PX are formed in such a way that they can be easily connected to the data lines D₁ to Dₘ or the dummy lines L1 and L2, that is, they have a connection distance that is as short as possible. Thus, in FIG. 3, the switching elements Q are disposed in different positions in every pixel row and column. That is, in the odd-numbered pixel pairs, a switching element Q is formed at the upper right side of a pixel PX that is disposed at the left side of the data lines D₁ to Dₘ, whereas a pixel PX disposed at the right side of the data lines D₁ to Dₘ is formed at the lower right portion of a pixel PX disposed at the right side of the data lines D₁ to Dₘ.

On the other hand, a switching element Q of a pixel PX disposed in the even-numbered row is formed in the opposite position with respect to its adjacent pixel row. That is, in the even-number pixel pairs, a pixel PX disposed at the left side of the data lines D₁ to Dₘ includes its switching element Q at the left lower portion, and a pixel disposed at the right side of the data lines D₁ to Dₘ includes its switching element Q at the left upper portion.

In brief, in the pixel electrodes 191 and the data lines D₁ to Dₘ of FIG. 3, switching elements Q of two pixels PX disposed between two adjacent data lines of each pixel row are connected to the same data line. That is, in the odd-numbered pixel row, switching elements Q of the two pixels PX formed between the two data lines are connected to the right side data lines, and in the even-numbered pixel row, switching elements Q of the two pixels PX formed between the two data lines are connected to the left side data lines.

The disposition of FIG. 3 is only an example, and thus the pixel electrodes 191, the odd-numbered and the even-numbered data lines D₁ to Dₘ, and the gate lines G₁ to G₂ₙ may be connected in a different manner.

On the other hand, in order to implement color display, each of the pixels PX uniquely displays one of primary colors (spatial division), or each of the pixels PX alternately displays the primary colors according to time (time division).

A desired color can be obtained by a spatial or time combination of the primary colors. FIG. 2 shows an example of spatial division, in which each of the pixels PX includes a red, green, or blue color filter 230 in a region corresponding to the pixel electrode 191. The color filter 230 may be provided above the lower panel 100 as in FIG. 2 or alternatively provided below the lower panel 100.

In FIG. 3, each color filter 230 for a corresponding pixel PX is arranged in the order of red, green and blue of the primary colors in a row direction, and each pixel column is linearly arranged in a stripe manner in which each color filter 230 of the pixel column includes only one color of the primary colors.

At least one polarizer (not shown) for polarizing light is provided on outer surfaces of at least one of the two panels 100 and 200.

Referring back to FIG. 1, the gray voltage generator 800 generates two gray voltage sets (reference gray sets) corresponding to transmittance of the pixels PX. The one gray set has a positive value with respect to the common voltage Vcom, and the other gray voltage set has a negative value with respect to the common voltage Vcom.

The pair of gate drivers 400L and 400R are respectively disposed at the left side and the right side of the liquid crystal panel assembly 300, and are respectively connected to the odd-numbered gate lines G₁, G₃, . . . , G₂ₙ₋₁ and the even-numbered gate lines G₂, G₄, . . . , G₂ₙ, so as to apply a gate signal, which is composed of a combination of an external gate-on voltage Von and an external gate-off voltage Voff, to the gate lines G₁ to G₂ₙ. The gate drivers 400L and 400R include a plurality of stages arranged in a row substantially as a shift register, and are formed and integrated in the same process as forming the switching elements Q of the pixels PX. However, the gate drivers 400L and 400R may be placed in the form of an integrated circuit (“IC”).

The data driver 500 is connected to the data lines D₁ to Dₘ of the liquid crystal panel assembly 300 to select the gray voltage from the gray voltage generator 800 and apply the gray voltages as data signals to the data lines D₁ to Dₘ. Alternatively, in a case where the gray voltage generator 800 generates only a predetermined number of the reference gray voltages instead of all the gray voltages, the data driver 500 may generate the gray voltages for all of the grays by dividing the reference gray voltages and selecting the data signals among the generated gray voltages.

The signal controller 600 controls the gate drivers 400L and 400R, the data driver 500 and the gray voltage generator 800.

Each of the drivers 500, 600, and 800 may be directly mounted in a form of one or more driving IC chips on the LCD panel assembly 300. Alternatively, the drivers 500, 600 and 800 may be mounted in a form of a tape carrier package (“TCP”) on a flexible printed circuit (“FPC”) film (not shown) in the LCD panel assembly 300, or may be mounted in a separate printed circuit board (not shown). Alternatively, the drivers 500, 600 and 800 together with the display signal lines G₁ to G₂ₙ and D₁ to Dₘ and the thin film transistor switching elements Q may be directly mounted on the LCD panel assembly 300.

In addition, the drivers 400, 500, 600 and 800 may be integrated in a form of a signal chip, and in this case, at least one of the drivers or at least one of circuit elements thereof may be present outside of the single chip.

Now, the operation of the liquid crystal display apparatus will be described with reference to FIG. 1.

The signal controller 600 receives input image signals R, G and B and input control signals for controlling display thereof from an external graphic controller (not shown). As an example of the input control signals, there are a vertical synchronization signal Vsync, a horizontal synchronization signal Hsync, a main clock signal MCLK and a data enable signal DE.

The signal controller 600 processes the input image signals R, G and B according to an operating condition of the liquid panel assembly 300 based on the input control signals and the input image signals R, G and B to generate a gate control signal CONT1, a data control signal CONT2, and the like, and then transmits the generated gate control signal CONT1 to the gate driver 400 and the generated data control signal CONT2 and the processed image signal DAT to the data driver 500.

The gate control signal CONT1 includes a scan start signal STV for indicating scan start and at least one clock signal for controlling an output period of the gate-on voltage Von. The gate control signal CONT1 may further include an output enable signal OE for defining a duration time of the gate-on voltage Von.

The data control signal CONT2 includes a horizontal synchronization start signal STH for indicating data transmission for (a pair of) one pixel row, a load signal LOAD for commanding to apply the associated data voltages to the data lines D₁ to Dₘ, and a data clock signal HCLK. The data control signal CONT2 may further include an inversion signal RVS for inverting a voltage polarity of the data signal with respect to the common voltage Vcom (hereinafter, “the voltage polarity of the data signal with respect to the common voltage Vcom” is abbreviated to a “data signal polarity”).

In response to the data control signal CONT2 from the signal controller 600, the data driver 500 receives a digital image signal DAT for (a pair of) one pixel row and selects the gray voltages corresponding to the digital image signal DAT, so that the digital image signal DAT is converted into an associated analog data signal. The analog data signal is then applied to the associated data lines D₁ to Dₘ.

The gate drivers 400L and 400R apply the gate-on voltage Von to the gate lines G₁ to G₂ₙ according to the gate control signals CONT1 from the signal controller 600 to turn on the switching elements Q connected to the gate lines G₁ to G₂ₙ. As a result, the data signals applied to the data lines D₁ to Dₘ are applied to the associated pixels PX through the turned-on switching elements Q.

A difference between the voltage of the data signal applied to the pixel PX and the common voltage Vcom becomes a charge voltage of the liquid crystal capacitors Clc, that is, a pixel voltage. Alignment of the liquid crystal molecules varies depending on the intensity of the pixel voltage. Therefore, polarization of light passing through the liquid crystal layer 3 changes. The change in the polarization results in a change in transmittance of the light due to the polarizer attached to the liquid crystal panel assembly 300.

In units of one horizontal period (or 1H), that is, one period of the horizontal synchronization signal Hsync and the data enable signal DE, the aforementioned operations are repeatedly performed to sequentially apply the gate-on voltages Von to all of the gate lines G₁ to G₂ₙ, so that the data signals are applied to all of the pixels. As a result, one frame of an image is displayed.

When one frame ends, the next frame starts, and a state of the inversion signal RVS applied to the data driver 500 is controlled, so that the polarity of the data signal applied to each of the pixels is opposite to the polarity in the previous frame (frame inversion). At this time, even in one frame, according to the characteristics of the inversion signals RVS, the polarity of data signals flowing through the one data line may be inverted (e.g. row inversion and dot inversion). In addition, the polarities of the data signals applied to the one pixel row may be different from each other (e.g. column inversion and dot inversion).

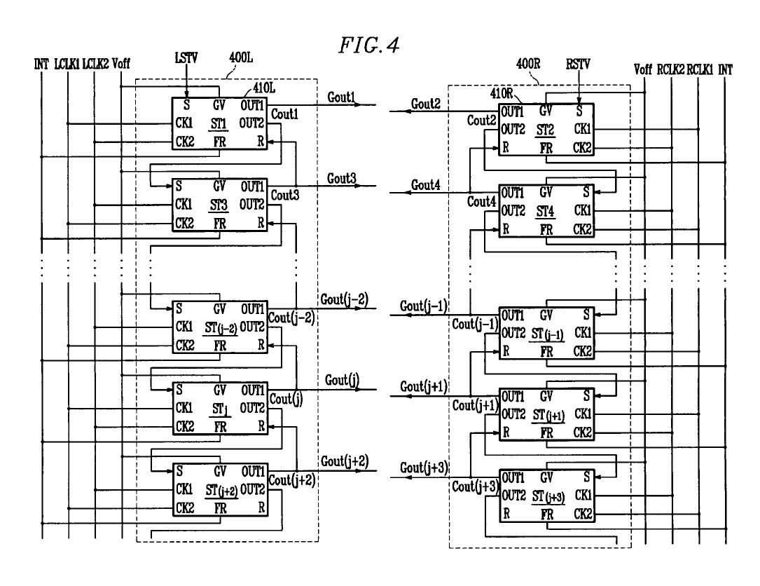

Now, a liquid crystal display apparatus according to an exemplary embodiment of the present invention will be described with reference to FIGS. 4 to 6.

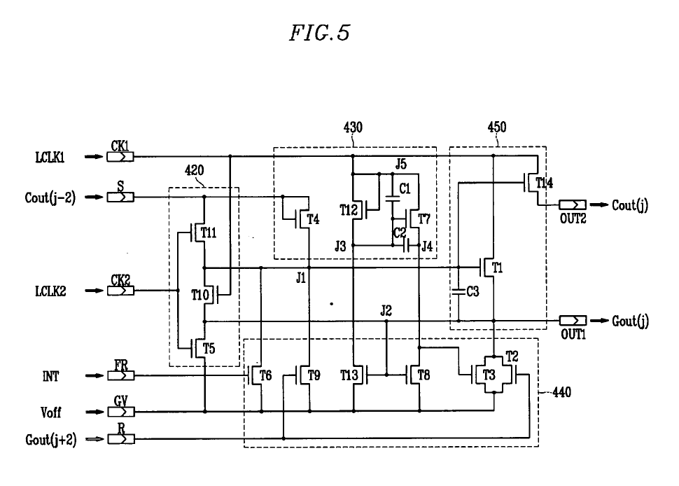

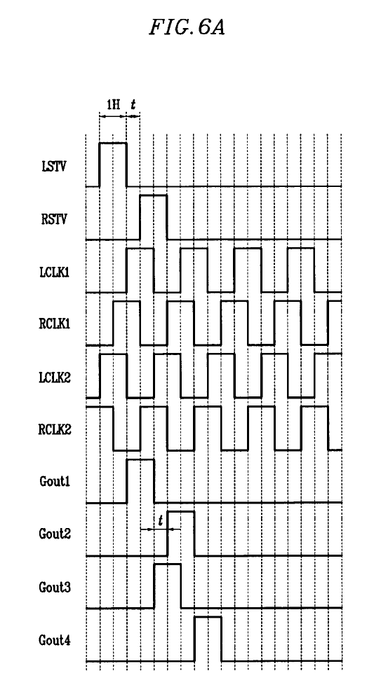

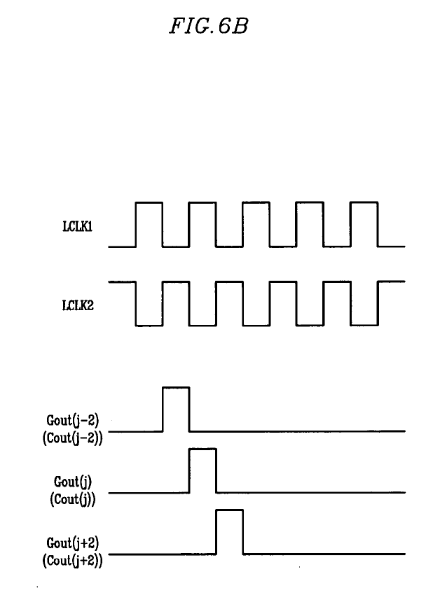

FIG. 4 is a block diagram of a gate driver according to an exemplary embodiment of the present invention. FIG. 5 is a circuit schematic diagram of a j-th stage of a shift register for a gate driver according an exemplary embodiment of the present invention. FIGS. 6A and 6B show signal waveforms of the gate driver of FIG. 4.

The gate driver includes first and second gates drivers 400L and 400R, respectively, which are shift registers 400L and 400R of FIG. 4. The shift registers 400L and 400R receive first and second scan start signals LSTV and RSTV, respectively, and corresponding first to fourth clock signals LCLK1, RCLK1, LCLK2 and RCLK2. Each of the shift registers 400L and 400R include a plurality of stages 410L and 410R arranged in a column, and each of the plurality of stages 410L and 410R are respectively connected to corresponding gate lines.

As shown in FIG. 6A, in the first scan start signal LSTV input to the left shift register 400L and the second scan start signal RSTV input to the right shift register 400R, one pulse having a width of 1H is included in one frame. The second scan start signal RSTV is delayed by a predetermined time t with respect to the first scan start signal LSTV. Each of the first to fourth clock signals LCLK1, RCLK1, LCLK2 and RCLK2 have a 50% duty ratio and a period of 2H. The first clock signal LCKL1 and the second clock signal RCLK1 have a phase difference equal to or greater than 180°. The third clock signal LCLK2 and the fourth clock signal RCLK2 also have a phase difference equal to or greater than 180°. On the other hand, the first clock signal LCKL1 and the third clock signal LCLK2, and the second clock signal RCLK1 and the fourth clock signal RCLK2, respectively, have phase differences of 180°.

A first vertical synchronization signal LSTV input to the first stage 410L of the left shift register 400L is in the high level when the first clock signal LCKL1 is in the low level, and becomes the low level when the first clock signal LCLK1 becomes the high level. In addition, a second vertical synchronization signal RSTV input to the first stage 410R of the right shift register 400R is in the high level when the second clock signal RCKL1 is in the low level, and becomes the low level when the second clock signal RCLK1 becomes the high level.

The two stages 410L and 410R of the respective shift registers 400L and 400R respectively receive the clock signals LCLK1, RCLK1, LCLK2 and RCLK2 that are different from one another. For example, the first clock signal LCKL1 is input to the first stage of the left shift register 400L, the third clock signal LCLK2 is input to the second stage of the left shift register 400L, the second clock signal RCLK1 is input to the first stage of the right shift register 400R, and the fourth clock signal RCLK2 is input to the second stage of the right shift register 400R.

In order to drive the switching elements Q of the pixels, each of the clock signals LCLK1, RCLK1, LCLK2 and RCLK2 may be the gate-on voltage Von during the high level, and may be the gate-off voltage Voff during the low level.

Each of the stages 410L and 410R has a set port S, a gate voltage port GV, a pair of clock ports CK1 and CK2, a reset port R, a frame reset port FR, a gate output port OUT1, and a carry output port OUT2.

In each stage, for example a j-th stage ST(j), the set port S is applied with a carry output of a previous stage ST(j−2), that is, a previous-stage carry output Cout(j−2), and the reset port R is applied with a gate output of a next stage ST(j+2), that is, a next-stage gate output Gout(j+2). In addition, the clock ports CK1 and CK2 are applied with the clock signals LCLK1 and LCLK2, respectively, and the gate voltage port GV is applied with the gate-off voltage Voff. The gate output port OUT1 transmits a gate output Gout(j), and the carry output port OUT2 transmits a carry output Cout(j) to the set port S of a next stage (STj+2).

However, first stages of the stage groups 41oL and 410R are respectively applied with the scan start signals LSTV and RSTV instead of the previous-stage gate outputs. When the clock ports CK1 and CK2 of the j-th state ST(j) are applied with the clock signals LCLK1 and LCLK2, respectively, the clock ports CK1 and CK2 of the (j−2)-th and (j+2)-th stages ST(j−2) and ST (j+2) adjacent to the j-th stage ST(j) are applied with the clock signals LCLK2 and LCLK1, respectively.

Referring to FIG. 5, each stage, for example the j-th stage, of the gate driver 400 according to the exemplary embodiment of the present invention includes an input portion 420, a pull-up driver 430, a pull-down driver 440 and an output portion 450. Each of the above elements includes one or more NMOS transistors T1 to T14. The pull-down driver 440 and the output portion 450 further include capacitors C1 to C3. PMOS transistors may be used instead of the NMOS transistors T1 to T14. In addition, the capacitors C1 and C3 may be parasitic capacitors formed between drain and source electrodes during production processes.

The input portion 420 includes three transistors T11, T10 and T5 respectively connected to the set port S and the gate voltage port GV in series. Gates of the transistors T11 and the T5 are connected to the clock port CK2, and a gate of the transistor T10 is connected to the clock port CK1. A contact point between the transistor T11 and the transistor T10 is connected to a contact point J1, and a contact point between the transistor T10 and the transistor T5 is connected to a contact point J2.

The pull-up driver 430 includes the transistor T4 connected between the set port S and the contact point J1, the transistor T12 connected between the clock port CK1 and a contact point J3, and the transistor T7 connected between the clock port CK1 and a contact point J4. A gate and a drain of the transistor T4 are commonly connected to the set port S, and a source thereof is connected to the contact point J1. A gate and a drain of the transistor T12 are commonly connected to the clock port CK1, and a source thereof is connected to the contact point J3. A gate of the transistor T7 is connected to the contact point J3 and is connected to the clock port CK1 through the capacitor C1, a drain thereof is connected to the clock port CK1, and a source thereof is connected to the contact point J4. The capacitor C2 is connected between the contact point J3 and the contact point J4.

The pull-down driver 440 includes a plurality of transistors T6, T9, T13, T8, T3 and T2 that receive the gate-off voltage Voff through their sources to output to the contact points J1, J2, J3 and J4. A gate of the transistor T6 is connected to the frame reset port FR, and a drain thereof is connected to the contact point J1. A gate of the transistor T9 is connected to the reset port R, and a drain thereof is connected to the contact point J1. Gates of the transistors T13 and T8 are commonly connected to the contact point J2, and drains thereof are respectively connected to the contact points J3 and J4. A gate of the transistor T3 is connected to the contact point J4 and drain of the transistor T8, and a gate of the transistor T2 is connected to the reset port R. Drains of the two transistors T3 and T2 are connected to the contact point J2.

The output portion 450 includes a pair of transistors T1 and T14 of which drains and sources are respectively connected to the clock port CK1 and between the output ports OUT1 and OUT2 and of which gates are connected to the contact point J1. The capacitor C3 is connected between the gate and drain of the transistor T1, that is, between the contact point J1 and the contact point J2.

Now, operations of the stages will be described.

For better comprehension and ease of description, a voltage corresponding to the high level of the clock signals LCLK1, LCLK2, RCLK1 and RCLK2 is referred to as a high voltage, and a voltage corresponding to the low level of clock signals LCLK1, LCLK2, RCLK1 and RCLK2 is referred to as a low voltage, which is equal to the gate-off voltage Voff.

First, when the clock signal LCLK2 and the previous-stage carry output Cout(j−2) are in the high level, the transistors T11, T5, and T4 turn on. Accordingly, the two transistors T11 and T4 transmit the high voltage to the contact point J1, and the transistor T5 transmits the low voltage to the contact point J2. As a result, the transistors T1 and T14 turn on, and the clock signal LCLK1 is output to the output ports OUT1 and OUT2. At this time, since both the contact point J2 and the clock signal LCLK1 have the low voltage, the output voltages Gout(j) and Cout(j) become the low voltage. At the same time, the capacitor C3 is charged with a voltage corresponding to a difference between the high voltage and the low voltage.

At this time, the clock signal LCLK1 and the next-stage gate output Gout(j+2) are in the low level, and the contact point J2 is also in the low level, so that all the transistors T10, T9, T12, T13, T8, and T2 of which gates are connected to the clock signal LCLK1 or the next-stage gate output Gout(j+2) are in the off state.

Subsequently, when the clock signal LCLK2 is in the low level, the transistors T11 and T5 turn off. In this state, if the clock signal LCLK1 becomes the high level, the output voltage of the transistor T1 and the voltage at the contact point J2 become the high voltage. At this time, the high voltage is applied to the gate of the transistor T10, but the source thereof connected to the contact point J2 also has the same high voltage. As a result, a potential difference between the gate and the source becomes 0, and thus the transistor T10 maintains the turn-off state. Accordingly, the contact point J1 becomes a floating state, and thus the electrical potential of the contact point J1 increases by the high voltage.

Meanwhile, since the electrical potential of the clock signal LCKL1 and the contact point J2 are at the high voltage, the transistors T12, T13, and T8 turn on. In this state, the transistors T12 and T13 are connected in series to have a voltage between the high voltage and the low voltage, and thus an electrical potential at the contact point J3 has a voltage divided by a turn-on resistance value of the two transistors T12 and T13. If the turn-on resistance value of the two transistors T13 is determined to be significantly higher than a turn-on resistance value of the transistor T12, for example about 10,000 times higher, then a voltage at the contact point J3 is almost the same as the high voltage. Accordingly, the transistor T7 turns on, and thus is connected to the transistor T8 in series. As a result, the contact point J4 has an electrical potential corresponding to a voltage divided by a turn-on resistance value of the two transistors T7 and T8. In this case, if the turn-on resistance values of the two transistors T7 and T8 are determined to be almost the same, the contact point J4 has an electrical potential corresponding to a median value between the high voltage and the low voltage, and thus the transistor T3 maintains the turn-off state. At this time, since the next gate output Gout(j+2) is still in the low level, the transistors T9 and T2 also maintain the turn-off state. Therefore, the output ports OUT1 and OUT 2 are connected to only the clock signal CLK1 and are blocked from the low voltage, thereby transmitting the high voltage.

The capacitors C1 and C2 are respectively charged with a voltage corresponding to an electrical potential difference between the two ports thereof. Here, the voltage at the contact point J3 is lower than the voltage at the contact point J5.

Next, the next gate output Gout(j+2) and the clock signal LCLK2 are in the high level and the clock signal LCLK1 is in the low level, so that the transistors T9 and T2 turn on to transmit the low voltage to the contact points J1 and J2. In this case, the voltage at the contact point J1 is discharged by the capacitor C3, and decreases to the low voltage. It takes some time for the voltage to be entirely reduced to the low voltage due to a charging time of the capacitor C3. For this reason, the two transistors T1 and T14 stay at the turn-on state for a while after the next gate output Gout(j+2) becomes the high level, and thus the output ports OUT1 and OUT2 are connected to the clock signal LCLK1, thereby transmitting the low voltage. Next, when the capacitor C3 is entirely discharged, and the electrical potential at the contact point J1 reaches the low voltage, the transistor T14 turns off, and the output port OUT2 is blocked from the clock signal LCLK1. As a result, the carry output Cout(j) becomes a floating state, thereby maintaining the low voltage. Since the output port OUT1 is connected to the low voltage through the transistor T2 even when the transistor T1 turns off, the output port OUT1 continuously transmits the low voltage.

Since the transistors T12 and T13 turn off, the contact point J3 becomes the floating state. In addition, the voltage at the contact point J5 becomes lower than the voltage at the contact point J4, and the voltage at the contact point J3 stays lower than the voltage at the contact point J5, thereby turning off the transistor T7. In this case, since the transistor T8 also transitions to the turn-off state, the voltage at the contact point J4 decreases as such, and the transistor T3 also maintains the turn-off state. In addition, the gate of the transistor T10 is connected to the low voltage of the clock signal LCLK1, and the voltage at the contact point J2 is in the low level. Therefore, the transistor T10 also maintains the turn-off state.

Next, when the clock signal LCLK1 is in the high level, the transistors T12 and T7 turn on, and the voltage at the contact point J4 increases. As a result, the transistor T3 turns on so as to transmit the low voltage to the contact point J2, and thus the output port OUT1 continuously transmits the low voltage. That is, even when the next gate output Gout(j+2) is in the low level, the voltage at the contact point J2 may be the low voltage.

Meanwhile, the gate of the transistor T10 is connected to the high voltage of the clock signal LCLK1, and the voltage at the contact point J2 is the low voltage. Thus, the transistor T10 turns on to transmit the low voltage at the contact point J2 to the contact point J1. The drains of the two transistors T1 and T14 are connected with the clock port CK1 so as to continuously receive the clock signal LCLK1. In particular, the transistor T1 is relatively larger in size than the rest of the transistors, and this may increase parasitic capacitance between the gate and the drain thereof. Thus, a voltage change of the drain may affect a gate voltage. Accordingly, when the clock signal LCLK1 becomes the high level, the gate voltage may increase due to the parasitic capacitance between the gate and the drain, thereby turning on the transistor T1. Therefore, by transmitting the low voltage at the contact point J2 to the contact point J1, the gate voltage of the transistor T1 can be maintained to be the low voltage, thereby preventing the transistor T1 from turning on.

Thereafter, the voltage at the contact point J1 stays at the low voltage until the previous-stage carry output Cout(j−2) becomes the high level. The voltage at the contact point J2 becomes the low voltage through the transistor T3 when the clock signal LCLK1 is in the high level, and the clock signal LCLK2 is in the low level. Otherwise, the voltage at the contact point J1 stays at the low voltage through the transistor T4.

The transistor T6 receives an initialization signal INT generated from a last dummy-state (not shown), and transmits the gate-off voltage Voff to the contact point J1 so that the voltage at the contact point J1 is maintained again at the low voltage.

In this manner, the stage 410L generates the carry output Cout(j) and the gate output Gout(j) based on the previous-stage carry output Cout(j−2) and the next gate output Gout(j+2) in synchronization with the clock signals LCLK1 and LCLK2.

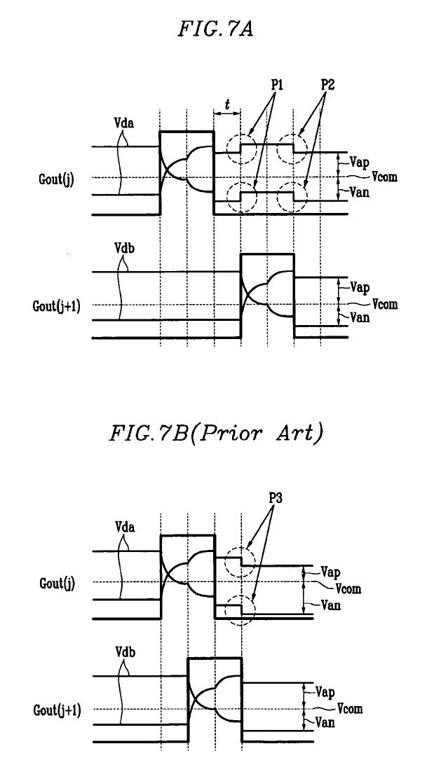

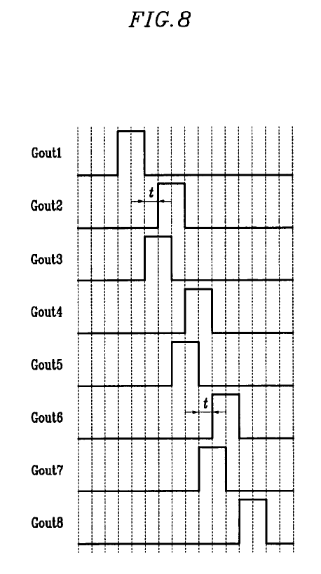

FIG. 7A shows waveforms of a gate signal and a data voltage according to an exemplary embodiment of the present invention. FIG. 7B shows waveforms of a gate signal and a data voltage according to the prior art.

As shown in FIG. 3, the gate signal indicates the j-th output Gout(j) and the (j+1)-th output [Gout(j+1) applied to a pixel set (Pa, Pb) constituting one pixel that is located in the same pixel row and are connected to the same data lines D₁ to Dₘ. In addition, the data voltage indicates positive and negative data voltages Vda and Vdb (indicated as either (“−”) or (“+”) applied to each pixel set (Pa, Pb).

Referring to FIG. 7A, the first clock signal LCLK1 and the second clock signal RCLK1 are separated from each other by a predetermined time t. The predetermined time t may be equal to or greater than 0 and less than 1H. In terms of a phase difference, this may be equal to or greater than 180° and less than 360°. As an example in the drawing, the predetermined time t is 1H/2 indicative of the separation between the first clock signal LCLK1 and the second clock signal RCLK1, that is, 270°.

In the pixel set (Pa, Pb), a data voltage of the pixel Pb, to which a gate signal is applied later, is substantially not affected by parasitic capacitance. The same applies to FIG. 7B. However, a data voltage of the pixel Pa, to which a gate signal is first applied, increases or decreases due to a kickback voltage.

That is, as for the data voltage Vda applied to the pixel Pa, a precharge voltage is first applied when the gate output Gout(j) transitions from the low level to the high level, and then a target voltage is applied when a first half stage (or 1H/2) of the high level of the gate output Gout(j) elapses. Thereafter, a main charge is carried out.

Next, when the gate output Gout(j) transitions from the high level to the low level, a pixel voltage decreases due to the kickback voltage generated by the parasitic capacitance between wires. However, when the next-stage gate voltage Gout(j+1) transitions from the low level to the high level after the predetermined time t elapses, a kickback voltage generated at a point P1 raises the pixel voltage (positive kickback voltage). Also, a kickback voltage generated at a point P2 when the next-stage gate voltage Gout(j+1) in the low level reduces the pixel voltage (negative kickback voltage), thereby returning back to the pixel voltage prior to being raised. Then, as shown in FIG. 7A, the positive pixel voltage Vap and the negative pixel voltage Van become substantially the same, thereby preventing flicker or stain. In this case, since the common voltage Vcom is predetermined by considering voltage reduction due to the kickback voltage that occurs about one time, the positive and negative pixel voltages Vap and Van become substantially the same.

In addition, if the predetermined time t is 0, that is, the falling edge of the gate output Gout(j) coincides with the rising edge of the gate output Gout(j+1), the positive kickback voltage and the negative kickback voltage are offset from each other while rising and falling, and thus the data voltage does not increase or decrease. The result thereof is the same as in the case of having the predetermined time t since the negative kickback voltage is generated only at the falling edge of the gate output Gout(j+1), thereby decreasing the data voltage only one time.

Referring to FIG. 7B, a portion of each of the two gate signals Gout(j) and Gout(j+1) overlap each other. Therefore, as shown in the drawing, the voltage is reduced one more time not only when the gate output Gout(j) falls but also when the next gate output Gout(j+1) falls. Accordingly, voltage reduction occurs twice, and thus a voltage difference between the positive pixel voltage Vap and the negative pixel voltage Van becomes much larger than that of FIG. 7A. This voltage difference between the positive pixel voltage Vap and the negative pixel voltage Van may cause flicker.

FIG. 8 shows first to eighth gate outputs Gout1 to Gout8 according to an exemplary embodiment of the present invention.

Referring to FIG. 8, the second gate output Gout 2 overlaps the third gate voltage Gout3 and the fifth gate output Gout5. In addition, the fourth gate output Gout4 partially overlaps the fifth gate output Gout5 and the seventh gate output Gout7. A pixel that receives the second gate output Gout2 is precharged when a data voltage is applied to a pixel that receives the third gate voltage Gout3. A pixel that receives the fifth gate voltage Gout5 is precharged when the data voltage is applied to a pixel that receives the second gate output Gout2. Likewise, the fifth and seventh gate signals Gout5 and Gout7 are also precharged in the same manner.

However, no signal overlaps with the first gate output Gout1. In addition, no signal overlaps with the third gate output Gout3 in the first half stage 1H/2 of the high level. In this case, therefore, a pixel that receives the gate signals Gout1 and Gout3 is not precharged. To solve this problem, a data voltage may be applied to a first pixel row equal to or greater than 1H, for example, 3H/2. By doing so, a pixel of the first pixel row can be precharged to a data voltage applied to the pixel itself, and a pixel of a third pixel row can be precharged to a data voltage applied to the pixel of the first pixel row.

In this manner, by separately applying the gate signals to the pixel set (Pa, Pb) with a predetermined time delay, voltage drop caused by parasitic capacitance occurs only one time. Thus, the negative pixel voltage can be the same as the positive pixel voltage, thereby preventing flicker or stain.

Although the exemplary embodiments and the modified examples of the present invention have been described, the present invention is not limited to the exemplary embodiments and examples, but may be modified in various forms without departing from the scope of the appended claims, the detailed description, and the accompanying drawings of the present invention. Therefore, it is natural that such modifications belong to the scope of the present invention.

What is claimed is:

1. A driver for a display apparatus comprising:
a plurality of gate lines which transmit gate signals; and
first and second gate drivers respectively connected to odd-numbered and even-numbered gate lines among the plurality of gate lines, the first and second gate drivers generate the gate signals based on a plurality of clock signals,
wherein two adjacent clock signals among the plurality of clock signals have a phase difference equal to or greater than 180° and less than 360°.

2. The driver of claim 1, wherein two non-adjacent clock signals among the plurality of clock signals have a phase difference of 180°.

3. The driver of claim 2, wherein the plurality of clock signals each have a duty ratio of 50%.

4. The driver of claim 1, wherein the plurality of clock signals comprise first to fourth clock signals, and the first and second clock signals or the third and fourth clock signals have phase differences equal to or greater than 180° and less than 360°.

5. The driver of claim 4, wherein the first and third clock signals or the second and fourth clock signals have phase differences of 180°.

6. The driver of claim 5, wherein the first and third clock signals are input to the first gate driver, and the second and fourth clock signals are input to the second gate driver.

7. The driver of claim 6, wherein first and second output start signals are respectively input to the first and second gate drivers.

8. The driver of claim 7, wherein the first and second output start signals have a phase difference equal to or greater than 180° and less than 360°.

9. A display apparatus comprising:
a plurality of pixels arranged in a matrix;
a plurality of gate lines for transmitting a gate signal to the pixels;
a plurality of data lines for transmitting a data signal to the pixels; and
first and second gate drivers respectively connected to odd-numbered and even-numbered gate lines among the plurality of gate lines, the first and second gate drivers generate the gate signal based on a plurality of clock signals,
wherein two adjacent clock signals among the plurality of clock signals have a phase difference equal to or greater than 180° and less than 360°.

10. The display apparatus of claim 9, wherein two non-adjacent clock signals among the plurality of clock signals have a phase difference of 180°.

11. The display apparatus of claim 10, wherein the plurality of clock signals each have a duty ratio of 50%.

12. The display apparatus of claim 9, wherein the plurality of clock signals comprise first to fourth clock signals, and the first and second clock signals or the third and fourth clock signals have phase differences equal to or greater than 180° and less than 360°.

13. The display apparatus of claim 12, wherein the first and third clock signals or the second and fourth clock signals have phase differences of 180°.

14. The display apparatus of claim 13, wherein the first and third clock signals are input to the first gate driver, and the second and fourth clock signals are input to the second gate driver.

15. The display apparatus of claim 14, wherein first and second output start signals are respectively input to first and second gate drivers.

16. The display apparatus of claim 15, wherein the first and second output start signals have a phase difference equal to or greater than 180° and less than 360°.

17. The display apparatus of claim 16, wherein two contiguous pixels disposed in a row direction between two adjacent data lines among the plurality of pixels are connected to a same data line.

18. The display apparatus of claim 17, wherein the two contiguous pixels are connected to different gate lines from each other.

19. The display apparatus of claim 18, further comprising a data driver for generating the data signal,
wherein the data driver applies the data signal to a pixel that first receives the gate signal between the two contiguous pixels located in a first pixel row among a plurality of pixel rows arranged in a column direction.

20. The display apparatus of claim 9, wherein the first and second gate drivers are integrated into the display apparatus.
